(19) United States
(12) Patent Application Publication
(10) Pub. No.: US 2014/0175691 A1
(43) Pub. Date: Jun. 26, 2014

(54) MOLD PROTECTION APPARATUS, MOLD PROTECTION METHOD AND MOLD CLAMPING APPARATUS

(71) Applicant: Toshiba Kikai Kabushiki Kaisha, Tokyo (JP)

(72) Inventors: Haruyuki MATSUBAYASHI, Numazu-shi (JP); Harumichi TOKUYAMA, Odawara-shi (JP); Takeshi Iida, Numazu-shi (JP)

(73) Assignee: Toshiba Kikai Kabushiki Kaisha, Tokyo (JP)

(21) Appl. No.: 14/138,837

(22) Filed: Dec. 23, 2013

(30) Foreign Application Priority Data
Dec. 25, 2012 (JP) 2012-281495

(51) Int. Cl. B29C 45/84; B29C 45/76

(52) U.S. Cl. CPC B29C 45/844; B29C 45/7653
USPC 264/40.5; 425/154

(57) ABSTRACT

According to one embodiment, a mold protection apparatus for use in an opening/closing apparatus, the movable platen being formed to be movable in a direction towards or away from a fixed platen having a fixed mold and being fixedly provided with a movable mold, the mold protection apparatus comprises a deriving means, a calculating means, and a comparing means. The deriving means configured to obtain an actual operation drive force output from the motor. The calculating means configured to calculate a theoretical operation drive force of the motor. The comparing means configured to compare a difference between the actual operation drive force derived by the deriving means and the theoretical operation drive force calculated by the calculating means with a threshold value.

### CROSS-REFERENCE TO RELATED APPLICATIONS

This application is based upon and claims the benefit of priority from Japanese Patent Application No. 2011-281495, filed Dec. 25, 2012, the entire contents of which are incorporated herein by reference.

### BACKGROUND OF THE INVENTION

1. Field of the Invention

The present invention relates to a mold protection apparatus, a mold protection method, and a mold clamping apparatus for a mold having a movable mold and a fixed mold.

2. Description of the Related Art

In an injection molding machine, a die-casting machine, and others, a mold clamping apparatus that opens or closes a mold having a movable die and a fixed die is used. As such a mold clamping apparatus, there is known a technology that opens or closes a mold by moving a movable die plate that holds a movable mold with respect to a fixed die plate that holds a fixed mold.

In such a mold clamping apparatus, when a mold closing operation of the mold is performed in a state that interposed matter such as a molded article or foreign matter or the like is interposed between the movable mold and the fixed mold, the mold may possibly be damaged. Therefore, there is known a mold clamping apparatus comprising a mold pretention apparatus that protects a mold in the mold closing operation performed in a state that interposed matter is interposed.

Jpn. Pat. Appln. KOKAI Publication No. 2006-334820 discloses a technology that stops driving of a mold clamping motor when an actual torque, i.e., the torque of a mold clamping motor exceeds a preset limiting value in a monitoring section that is set at a position where a fixed mold and movable mold approach each other in a mold closing operation or the like as a mold protection apparatus used in a mold clamping apparatus. Further, Jpn. Pat. Appln. KOKAI Publication No. 2006-334820 discloses a technology that calculates the actual torque by operating an injection molding machine based on semi-automatic operation and setting a preset limiting value based on the calculated actual torque.

Jpn. Pat. Appln. KOKAI Publication No. 2004-330527 discloses, as a mold protection apparatus used in a mold clamping apparatus, a technology that determines abnormal processing when an actual torque of a servo motor configured to perform a mold closing operation in accordance with each of sampling periods set for a predetermined monitoring section exceeds a threshold value previously obtained from the actual torque of the servo motor at the time of a trial run in relation to a mold closing operation at a mold clamping step in a producing operation.

Jpn. Pat. Appln. KOKAI Publication No. 2004-142211 discloses a technology that provides a monitoring section in a mold clamping step based on a reference pattern representing a relationship of mold clamping force relative to a position of a movable plate when mold clamping was excellently carried out, and determines abnormality and raises an alarm when the mold clamping force converted from a torque value of a toggle mechanism driving motor exceeds an allowable limit value in the monitoring section.

Jpn. Pat. Appln. KOKAI Publication No. 2010-94726 discloses a technology that enables calculating a load torque which is a control command from a weight of a movable die and a movable platen.

### BRIEF SUMMARY OF THE INVENTION

According to an aspect of embodiments, a mold protection apparatus for use in an opening/closing apparatus that opens/closes a mold by moving a movable platen with use of a motor, the movable platen being formed to be movable in a direction towards or away from a fixed platen having a fixed mold fixed thereto and being fixedly provided with a movable mold to form the mold integral with the fixed mold, the mold protection apparatus comprises a deriving means, a calculating means, and a comparing means.

The deriving means configured to obtain an actual operation drive force output from the motor. The calculating means configured to calculate a theoretical operation drive force of the motor. The comparing means configured to compare a difference between the actual operation drive force derived by the deriving means and the theoretical operation drive force calculated by the calculating means with a threshold value.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory view showing a configuration of a mold clamping apparatus according to an embodiment of the present invention.

### DETAILED DESCRIPTION OF THE INVENTION

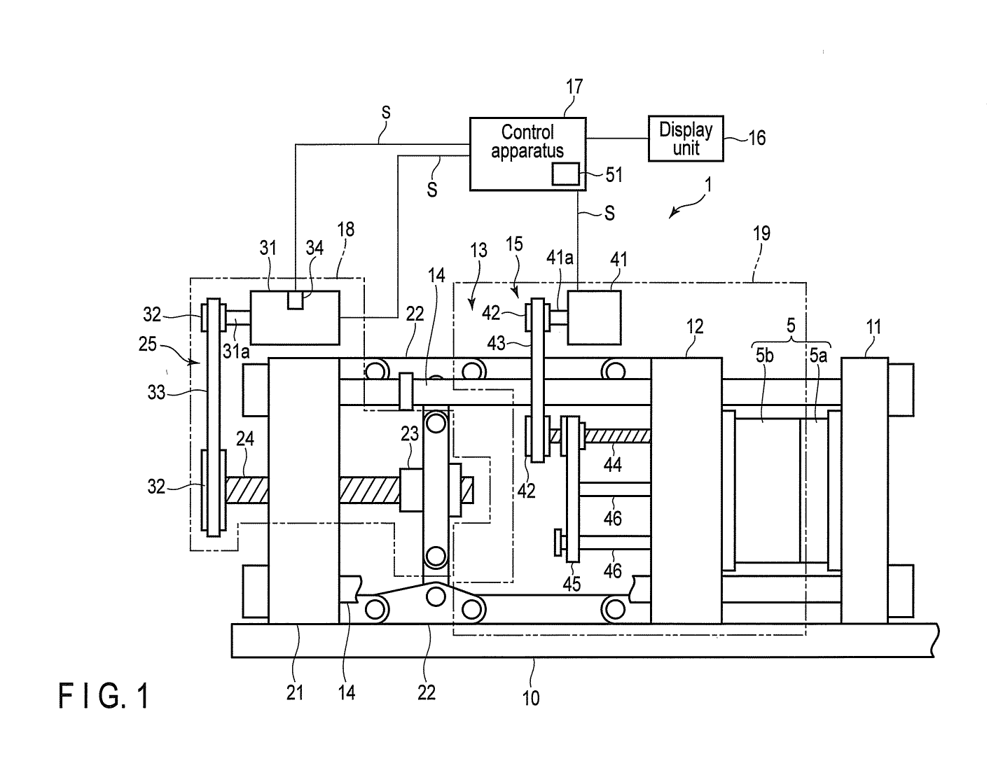

A mold clamping apparatus (an opening/closing apparatus) 1 according to an embodiment of the present invention will now be described hereinafter with reference to FIG. 1.

FIG. 1 is an explanatory view showing a configuration of the mold clamping apparatus 1 according to an embodiment of the present invention.

As shown in FIG. 1, the molding clamping apparatus 1 is formed to enable holding a mold 5 having a fixed mold 5a and a movable mold 5b and enable a mold opening operation and a mold closing operation of the mold 5. The mold clamping apparatus 1 comprises a support unit 10, a fixed platen (a fixed matter) 11, a movable platen (a movable matter) 12, an opening/closing mechanism 13, tie bars 14, an extruding mechanism 15, a display unit 16, and a control apparatus 17.

Further, the mold clamping apparatus 1 comprises a fixed portion 18 whose configuration is not changed and whose weight is fixed, i.e., whose weight has a fixed value and a changing portion 19 whose weight changes, i.e., whose weight has a variable value when a configuration thereby varies due to, e.g., replacement of a component. Such a mold clamping apparatus 1 is used for, e.g., an injection molding machine.

The support unit 10 is a so-called base or frame that supports the fixed platen 11, the movable platen 12, and the opening/closing mechanism 13. The fixed platen 11 is a so-called fixed die plate and is fixed to the support unit 10. The fixed platen 11 is formed to enable fixing the fixed mold 5a.

The movable platen 12 is a so-called movable die plate and is arranged on the support unit 10 to face the fixed platen 11. The movable platen 12 is formed to be movable in a direction towards or away from the fixed platen 11. Specifically, the movable platen 12 is formed so that it can linearly move (linear movement) in forward and backward directions with respect to the fixed platen 11 via the tie bars 14 by the opening/closing mechanism 13 or a non-illustrated mold thickness adjustment mechanism. The movable platen 12 is formed so that it can fix the movable mold 5b of the mold 5.

The opening/closing mechanism 13 is formed to enable opening/closing the mold 5, i.e., moving the movable mold 5b fixed to the movable platen 12 towards/away from the fixed mold 5a by linearly moving the movable platen 12 with use of a toggle mechanism. The opening/closing mechanism 13 comprises a link housing (a pressure receiving platen) 21, toggle links 22, a crosshead 23, a first ball screw 24, and a rotation mechanism 25.

The link housing 21 serves as a fulcrum of the toggle links 22 and the crosshead 23. The link housing 21 is supported on the support unit 10.

The toggle links 22 is connected to the movable platen 12, the link housing 21, and the crosshead 23. The toggle links 22 is formed of links, bushes, and pins constituting the toggle mechanism. The toggle links 22 is formed in such a manner that it can linearly move the movable platen 12 with respect to the fixed platen 11 when the toggle links 22 is operated by the crosshead 23.

The crosshead 23 is connected to the first ball screw 24 and formed in such a manner that it can move along a shaft center direction of the first ball screw 24 based on rotation of the first ball screw 24. Furthermore, the crosshead 23 is formed so that it can operate the toggle links 22 by moving along the shaft center direction of the first ball screw 24.

The rotation mechanism (a drive apparatus) 25 is constituted of a first servo motor (a motor, a drive unit) 31, a pair of first pulleys 32, a first timing belt 33, and an encoder 34.

The first servo motor 31 has a first rotary shaft 31a and is formed to enable rotating the first rotary shaft 31a. The first servo motor 31 is electrically connected to the control apparatus 17 through a signal line S or the like. The first servo motor 31 is a drive source that drives a changing portion 19. One of the pair of first pulleys 32 is fixed to the first rotary shaft 31a of the first servo motor 31, and the other of the same is fixed to the first ball screw 24, respectively.

The first timing belt 33 is provided between the pair of first pulleys 32 and formed so that it can transmit a rotary motion of the first pulley 32, which is specifically the first pulley 32 fixed to the first rotary shaft 31a of the first servo motor 31, to the first pulley 32 fixed to the first ball screw 24.

The encoder (a detector) 34 is detecting means formed so that it can detect the number of revolutions of the first rotary shaft 31a. The encoder 34 is connected to the control apparatus 17 through the signal line S and formed so that it can transmit information, e.g., the detected number of revolutions and rotating position of the first rotary shaft 31a to the control apparatus 17.

Such an opening/closing mechanism 13 transmits the rotary motion of the first rotary shaft 31a to the first ball screw 24 through the pair of first pulleys 32 and the first timing belt 33 and converts the rotary motion of the first ball screw 24 into the linear movement of the crosshead 23. Additionally, the opening/closing mechanism 13 transmits the linear movement of the crosshead 23 to the movable platen 12 through the toggle links 22. As a result, the opening/closing mechanism 13 is formed so that it can linearly move the movable platen 12 with respect to the fixed platen 11.

The plurality of tie bars 14 are provided to be fixed to, e.g., the fixed platen 11 and the link housing 21. The tie bars 14 are formed to couple the fixed platen 11 and the link housing 21, and they are formed to enable guiding movement of the movable platen 12. For example, the four tie bars 14 are arranged at four corners of the fixed platen 11 and the link housing 21.

The extrusion mechanism 15 is connected to the movable platen 12, and it protrudes extrusion pins A6 from the movable mold 5b by moving an extrusion platen 45 and extrudes a molded article. Further, since the extrusion mechanism 15 is connected to the movable platen 12, it affects a change in the changing portion 19 like the movable platen 12 or the movable mold 5b at the time of opening or closing the mold. For example, the extrusion mechanism 15 comprises a second servo motor 41, a pair of second pulleys 42, a second timing belt 43, a second ball screw 44, the extrusion platen 45, and the extrusion pins 46.

In FIG. 1, as indicated by a dashed line of alternate long and two short dashes, the fixed portion 18 is constituted of, e.g., the crosshead 23, the first ball screw 24, the first servo motor 31, the pair of first pulleys 32, the first timing belt 33, and the encoder 34.

In FIG. 1, as indicated by a dashed line of alternate long and two short dashes, the changing portion 19 is constituted of, e.g., the movable mold 5b, the movable platen 12, the extrusion mechanism 15, and part of the toggle links 22 that moves together with the movable platen 12 in a sliding direction of the movable platen 12 with movement of the crosshead 23. A weight of the changing portion 19 varies in accordance with the movable mold 5b to be adopted even in the same model.

The display unit 16 is, e.g., a liquid crystal display connected to the control apparatus 17. The display unit 16 is formed so that it can display,a state of the mold clamping apparatus 1 based on a command from the control apparatus 17. For example, the display unit 16 is formed so that it can display a graph showing a position of the movable platen 12 and deviation torque of the movable platen 12 on an abscissa and an ordinate, respectively and can also display later-described low-pressure mold clamping force TI in the graph. It is to be noted that ‘torque’ means a thrust or driving force, and ‘deviation torque’ of the movable platen 12 means a difference between later-described actual operation torque (actual operation drive force) T and theoretical operation torque (theoretical operation drive force) Tt.

The control apparatus 17 is electrically connected to the first servo motor 31 and the encoder 34 through the signal line S. The control apparatus 17 comprises a storage unit 51 that stores information of each component of the mold clamping apparatus 1.

The storage unit 51 stores an inertia of the fixed portion 18, i.e., first inertia (a first moment of inertia) Jf based on a weight, a shape, etc. of the fixed portion 18.

Furthermore, the storage unit 51 stores a friction coefficient umax at a maximum speed of the movable platen 12, a memory table that enables deriving a position of the movable platen 12 from a position of the crosshead 23, a weight FMP of the movable platen 12, a weight FMD of the movable mold 5b, molding conditions for molding, low-pressure mold clamping force TI which is a threshold value that enables avoiding damage to the mold 5 even though an interposed matter is interposed in the mold 5, and other values.

The friction coefficient umax represents the viscous friction at the maximum speed of the movable platen 12, and is obtained from configurations of the movable platen 12, the opening/closing mechanism 13, and the tie bars 14 and stored in the storage unit 51 in advance. Furthermore, the low-pressure mold clamping force TI is a threshold value that is obtained from a material and the like of the mold 5 and enables avoiding damage to the mold 5, and is input to the storage unit 51 in advance. Moreover, the weight FMD of the movable mold 5b is input every time the mold 5 is replaced, or is obtained from a weight of the mold 5 that is part of the molding conditions called from the storage unit 51 and stored in the storage unit 51. The weight FMD of the movable mold 5b is obtained from, e.g., ½ of a total weight of the mold (the weight FMD of the movable mold 5b=the total weight of the mold 5/2) and stored in the storage unit 51.

The control apparatus 17 is formed so that it can display an opened/closed state of the mold 5, information of a position and thrust of the movable platen 12, the low-pressure mold clamping force TI, and normality/abnormality of the opening/closing operation in the display unit 16.

Additionally, the control apparatus 17 has the following functions:

(1) a function of obtaining moving lengths of the crosshead 23 and the movable platen 12 and a speed ratio r of the crosshead 23 and the movable platen 12 from positional information of the first rotary shaft 31a;

(2) a function of calculating a weight FM of the changing portion 19;

(3) a function of calculating the theoretical operation torque Tt;

(4) a function of comparing the deviation torque of the movable platen 12 with the low-pressure mold clamping force TI; and

(5) a function of performing a mold protecting operation at the time of closing the mold.

The function (1) to the function (5) of the control apparatus 17 will now be described.

The function (1) is a function of deriving positional information of the crosshead 23 from the number of revolutions of the first rotary shaft 31a detected by the encoder 34 based on a moving length (a coving amount) of the crosshead 23 relative to the number of revolutions of the first ball screw 24 stored in the storage unit 51 in advance. Further, the function (1) is also a function of deriving positional information and a moving length (a coving amount) of the movable platen 12 from the derived positional information and the moving length of the crosshead 23 and the memory table stored in the storage unit 51. Furthermore, the function (1) is also a function of calculating the speed ratio r from the derived moving length of the crosshead 23 and the moving length of the movable platen 12. It is to be noted that the speed ratio r is obtained from r=(the moving length of the crosshead 23/the moving length of the movable platen 12).

The function (2) is a function of calculating the weight FM of the changing portion 19 from the weight FMP of the movable platen 12 and the weight FMD of the movable mold 5b stored in the storage unit 51, the friction coefficient u, and the speed ratio r of the crosshead 23 and the movable platen 12.

Specifically, according to the function (2), since the friction coefficient umax stored in the storage unit 51 is the friction force at the maximum speed of the movable platen 12, the friction coefficient u is first calculated from the friction coefficient umax and a moving length and a moving time of the movable platen 12 that are obtained with use of the function (1) based on a speed of the actually operated movable platen 12.

Then, the weight FM of the changing portion 19 is calculated by using the following expression:

FM=(FMP+FMD)×(1+u)×r

Additionally, the weight FM of the changing portion 19 is determined as an inertia of the changing portion 19, i.e. a second inertia (a second moment of inertia) Jr. That is, Jr=FM is determined.

The function (3) is a function of calculating the theoretical operation torque Tt from the first inertia Jf stored in the storage unit 51, acceleration αf of the crosshead 23, the second inertia Jr obtained with use of the function (2), and acceleration αr of the movable platen 12.

Specifically, according to the function (3), the acceleration αf of the crosshead 23 is first calculated from the number of revolutions of the first rotary shaft 31a detected by the encoder 34. It is to be noted that the acceleration αf is obtained from, e.g., the moving length and the moving time of the crosshead 23. Likewise, the acceleration αr of the movable platen 12 is calculated from the moving length of the movable platen 12 obtained with use of the function (1). It is to be noted that the acceleration αr of the movable platen 12 is obtained from, e.g., the moving length and the moving time of the movable platen 12.

Then, the theoretical operation torque Tt is calculated from the following expression:

Tt=αf×Jf+αr×Jr

As described above, the function (3) of the control apparatus 17 constitutes calculating means for calculating the theoretical operation torque Tt from the number of revolutions of the first servo motor 31.

According to the function (4), a difference between the actual operation torque T that can be obtained from the configuration of the first servo motor 31 and a current allowed to flow through the first servo motor 31 and actually output from the first servo motor 31 and the theoretical operation torque Tt obtained with use of the function (3), which is the deviation torque of the movable platen 12, is compared with the low-pressure mold clamping force TI. Furthermore, according to this function, whether the difference between the actual operation torque T and the theoretical operation torque Tt (the deviation torque) is greater than the low-pressure mold clamping force TI or not smaller than the low-pressure mold clamping force TI is determined.

Specifically, whether the difference between the actual operation torque T and the theoretical operation torque Tt (the deviation torque) is greater than the low-pressure mold clamping force TI or not smaller than the low-pressure mold clamping force TI is determined by using one of the following expressions:

TI≦T−Tt

or

TI<T−Tt

As described above, the function (4) of the control apparatus 17 constitutes deriving means for obtaining the actual operation torque T output from the first servo motor 31. Moreover, the function (4) constitutes comparing means for comparing a difference between the obtained actual operation torque T and the theoretical operation torque Tt calculated based on the function (3) with the low-pressure clamping force TI which is a threshold value.

According to the function (5), when the function (4) revealed that the difference between the actual operation torque T and the theoretical operation torque Tt is greater than the low-pressure mold clamping force TI or not smaller than the low-pressure mold clamping force TI, it is determined that interposed matter is interposed between the fixed mold 5a and the movable mold 5b, namely, that there is an abnormality. According to this function, based on this determination, the first servo motor 31 is stopped, the movement of the movable platen 12 is stopped, the mold closing operation of the mold 5 is stopped, and the mold protecting operation for avoiding damage to the mold 5 due to the interposed matter is carried out.

It is to be noted that, in the function (5), after the control apparatus 17 determined the abnormality, the timing for stopping the first servo motor 31 is set to be either quickly stopping in accordance with the low-pressure mold clamping force TI stored in the storage unit 51 or stopping after elapsing of a predetermined time.

With the function (1) to the function (5) described above, the control apparatus 17 constitutes the mold protection apparatus. That is, the mold protection apparatus is constituted of the opening/closing mechanism 13 and the control apparatus 17, and it protects the mold by carrying out the control to stop the first servo motor 31 based on the low-pressure mold clamping force TI.

According to the thus configured mold clamping apparatus 1, the mold closing operation of the mold 5 is effected by using the opening/closing mechanism 13 and the control apparatus 17, monitoring is performed to avoid damage to the mold 5, and the mold protecting operation is effected when the mold 5 may be possibly damaged.

Specifically, when the control apparatus 17 is instructed to perform the mold closing operation from the outside or the inside of the control apparatus 17, the control apparatus 17 drives the first servo motor 31 based on this instruction and moves the movable platen 12 in a direction along which the movable mold 5b approaches the fixed mold 5a.

At this time, the control apparatus 17 obtains the moving lengths of the crosshead 23 and the movable platen 12 and the speed ratio r of the crosshead 23 and the movable platen 12 from the positional information of the first rotary shaft 31a detected by the encoder 34.

Then, the control apparatus 17 calculates the weight FM of the changing portion 19, i.e., the second inertia Jr, further calculates the theoretical operation torque Tt, and compares the difference between the actual operation torque T and the theoretical operation torque Tt with the low-pressure mold clamping force TI. The control apparatus 17 monitors whether the difference becomes greater than the low-pressure mold clamping force TI or whether the same becomes equal to or more than the low-pressure mold clamping force TI based on a result of the comparison between the difference and the low-pressure mold clamping force TI until end of the mold closing operation at which the movable mold 5b comes into contact with the fixed mold 5a.

When the difference is not greater than the low-pressure mold clamping force TI or smaller than the low-pressure mold clamping force TI, the control apparatus 17 determines that the mold closing operation is normally performed and displays this determination in the display unit 16.

When the difference is greater than the low-pressure mold clamping force TI or not smaller than the low-pressure mold clamping force TI, the control apparatus 17 determines that the mold closing operation is abnormal, stops the first servo motor 31, stops movement of the movable platen 12, and thereby performs the mold protecting operation. Further, the control apparatus 17 displays information that the mold protecting operation was carried out in the display unit 16.

According to the thus configured mold clamping apparatus 1, even if interposed matter is present between the fixed mold 5a and the movable mold 5b in the mold closing operation of the mold 5, the mold 5 can be prevented from being damaged by performing torque management with use of the mold protection apparatus constituted of the opening/closing mechanism 13 and the control apparatus 17 and carrying out the mold protecting operation when an abnormality is determined.

According to the mold protecting operation using the mold protection apparatus, the deviation torque is monitored based on whether the deviation torque is greater than the low-pressure mold clamping force TI or not smaller than the low-pressure mold clamping force TI, and the normal mold closing operation of the mold or the abnormal mold closing operation such as interposition of interposed matter can be determined. Moreover, when this state is displayed in the display unit 16, the normality and the abnormality of the mold closing operation can be easily confirmed.

As described above, based on the mold clamping apparatus 1 according to an embodiment of the present invention, monitoring of the deviation torque and detection of the abnormality in the mold closing operation can be performed, and the mold 5 can be prevented from being damaged by stopping movement of the movable platen 12 when the mold closing operation is abnormal.

It is to be noted that the present invention is not restricted to the foregoing embodiment. For instance, although the configuration formed of the opening/closing mechanism 13 and the control apparatus 17 of the mold clamping apparatus 1 has been described as the mold protection apparatus in the above example, the present invention is not restricted thereto. For example, the mold protection apparatus may be configured to control the opening/closing mechanism 13 separately from the control apparatus 17 and the opening/closing mechanism 13 and have mold protecting means such as a control unit that has the function (1) to the function (5).

Moreover, although the configuration used for an injection molding machine has been described as the mold clamping apparatus 1 in the foregoing example, the present invention is not restricted thereto. For example, the mold clamping apparatus 1 may be configured for use in a die-casting machine or a transfer molding machine or may be configured for use in a molding machine that uses the mold 5 having the fixed mold 5a and the movable mold 5b.

Additionally, although the description has been given as to the above example where the control apparatus 17 performs the mold protecting operation when the deviation torque of the movable platen 12 is greater than the low-pressure mold clamping force TI or not smaller than the low-pressure mold clamping force TI, the present invention is not restricted thereto. For example, the mold clamping apparatus 1 may comprise informing means such as an alarm or a siren, and it may be configured so that it can inform the informing means and the display unit 16 of abnormality by using the control apparatus 17 when the control apparatus 17 determines that the mold must be protected, i.e., that the mold closing operation is abnormal. It is to be noted that, when the mold clamping apparatus 1 is configured in this manner, an operator can effect emergency stop with respect to the first servo motor 31 after being informed of an abnormality, thereby performing the mold protecting operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mold protection apparatus for use in an opening/closing apparatus that opens/closes a mold by moving a movable platen with use of a motor, the movable platen being formed to be movable in a direction towards or away from a fixed platen having a fixed mold fixed thereto and being fixedly provided with a movable mold to form the mold integral with the fixed mold, the apparatus comprising:
a deriving means configured to obtain an actual operation drive force output from the motor;
a calculating means configured to calculate a theoretical operation drive force of the motor; and
a comparing means configured to compare a difference between the actual operation drive force derived by the deriving means and the theoretical operation drive force calculated by the calculating means with a threshold value.

2. The apparatus according to claim 1,
wherein the opening/closing apparatus comprises a crosshead that moves by the motor,
the deriving means obtains the actual operation drive force from a current allowed to flow through the motor and a configuration of the motor at the time of moving the movable platen, and
the calculating means calculates the theoretical operation drive force from accelerations of the crosshead and the movable platen, and inertias of the opening/closing apparatus and the movable platen.

3. A mold protection method of an opening/closing apparatus that opens/closes a mold by moving a movable platen with use of drive of a motor, the movable platen being formed to be movable in a direction towards or away from a fixed platen having a fixed mold fixed thereto and being fixedly provided with a movable mold to form the mold integral with the fixed mold, the method comprising:
obtaining an actual operation drive force output from the motor;
calculating a theoretical operation drive force of the motor; and
comparing a difference between the actual operation drive force and the theoretical operation drive force with a threshold value.

4. The method according to claim 3,
wherein the opening/closing apparatus has a crosshead that is moved by the motor,
the actual operation drive force is obtained from a current allowed to flow through the motor and a configuration of the motor at the time of moving the movable platen, and
the theoretical operation drive force is calculated from accelerations of the crosshead and the movable platen, and inertias of the opening/closing apparatus and the movable platen.

5. A mold clamping apparatus comprising:
a fixed platen to which a fixed mold is disposed;
a movable platen that is arranged to face the fixed platen and to which a movable mold is disposed;
an opening/closing mechanism that enables moving the movable platen; and
a control apparatus that controls the opening/closing mechanism,
wherein the opening/closing mechanism has a drive unit that produces a drive force that enables moving the movable platen, and
the control apparatus comprises: a deriving means configured to obtain an actual operation drive force output from the drive unit; a calculating means configured to calculate a theoretical operation drive force of the drive unit; and a comparing means configured to compare a difference between the actual operation drive force and the theoretical operation drive force calculated by the calculating means with a threshold value.

6. The apparatus according to claim 5,
wherein the opening/closing mechanism has a crosshead that moves by the drive unit,
the deriving means obtains the actual operation drive force from a current allowed to flow through the drive unit and a configuration of the drive unit at the time of moving the movable platen, and
the calculating means calculates the theoretical operation drive force from accelerations of the crosshead and the movable platen, and inertias of the opening/closing mechanism and the movable platen.
